(19) United States
(12) Patent Application Publication
(10) Pub. No.: US 2025/0121236 A1
(43) Pub. Date: Apr. 17, 2025

(54) FIREFIGHTING FOAMS CONTAINING ONE OR MORE SURFACTANTS AND ONE OR MORE ADDITIONAL COMPONENTS

(71) Applicant: PERIMETER SOLUTIONS LP, Clayton, MO (US)

(72) Inventors: Monica AMANDI, Mieres (ES); Pamela HAVELKA-RIVARD, De Pere, WI (US); Covadonga PEREZ, Mieres (ES); Carlson SUGIARTO, Green Bay, WI (US); Leilei ZHANG, Green Bay, WI (US)

(21) Appl. No.: 18/889,866

(22) Filed: Sep. 19, 2024

Related U.S. Application Data
(60) Provisional application No. 63/539,432, filed on Sep. 20, 2023.

(51) Int. Cl. A62D 1/02

(52) U.S. Cl. CPC A62D 1/0071

(57) ABSTRACT

The present invention is directed to firefighting foam compositions (e.g., concentrates, foam forming compositions, and solutions) including a combination of surfactants (e.g., anionic surfactants and amphoteric surfactants) and one or more additional components (e.g., polyethylene glycol (PEG), glycerin, and/or a sugar component).

### REFERENCE TO RELATED APPLICATIONS

This application claims the benefit of and priority to U.S. Provisional Patent Application Ser. No. 63/539,432, filed Sep. 20, 2023, the entire contents of which are hereby incorporated by reference.

### FIELD OF THE INVENTION

The present invention is directed to firefighting foam compositions (e.g., concentrates, foam forming compositions, and solutions) including a combination of surfactants (e.g., anionic surfactants and amphoteric surfactants) and one or more additional components (e.g., polyethylene glycol (PEG), glycerin, and/or a sugar component).

### BACKGROUND OF THE INVENTION

Aqueous firefighting foams are used against Class A fires involving ordinary combustible materials such as wood, cloth, paper, rubber, and many plastics. Effective Class A firefighting foams, including fluorine-free foams are known.

Aqueous firefighting foams are also used against Class B fires (i.e., fires fueled by flammable liquids). Such firefighting foams include both aqueous film-forming foams (AFFF) and alcohol-resistant aqueous film-forming foams (AR-AFFF). Effective Class B firefighting foams, including fluorine-free foams have also been developed.

Although effective Class A and Class B foams have been developed, opportunities exist for improvement and/or to provide alternative Class A and/or Class B foams.

For example, firefighting foam concentrates are typically tested for their foaming properties to determine their suitability for use in connection with different water sources, including fresh water, salt water (e.g., sea water, including sea water having high total suspended solids), and municipal water. Foams exhibiting acceptable performance when used with different water sources are desired to provide flexibility in use.

Firefighting foams suitable for use in connection with multiple types of fires (i.e., Class A and/or Class B) and multiple sources of water (i.e., fresh water, salt water, and municipal water) are desired and would provide an advantageous option for use in the art.

### BRIEF SUMMARY OF THE INVENTION

In various aspects, the present invention is directed to a firefighting foam concentrate, the concentrate comprising: at least one anionic surfactant; at least one amphoteric surfactant; and one or more other components (e.g., one or more components such as polyethylene glycol (PEG) and/or glycerin (propane-1,2,3-triol)). For example, various aspects of the present invention involve foam compositions including glycerin that provide improved performance such as, for example, improved burn back performance.

Various aspects of the present invention are directed to firefighting foam concentrates comprising at least one anionic surfactant; at least one amphoteric surfactant; and polyethylene glycol (PEG).

Various other aspects of the present invention are directed to a firefighting foam concentrate, the concentrate comprising: at least one anionic surfactant; at least one amphoteric surfactant; and glycerin (propane-1,2,3-triol), wherein glycerin constitutes at least about 5 wt %, at least about 8 wt %, or at least about 10 wt % of the concentrate composition.

Other aspects of the present invention are directed to a firefighting foam concentrate, the concentrate comprising: at least one anionic surfactant; at least one amphoteric surfactant; the composition further comprising: polyethylene glycol, and/or glycerin, and/or a sugar component, wherein: the composition does not contain any sultaine surfactant.

Various other aspects of the present invention are directed to firefighting foam solutions comprising any of the concentrates of the present disclosure (e.g., solutions containing at least or about 0.5 wt %, 1 wt %, 1.5%, 2 wt %, 3 wt %, 4 wt %, 5 wt %, or 6 wt % of a foam concentrate of the present disclosure).

Other objects and features will be in part apparent and in part pointed out hereinafter.

### BRIEF DESCRIPTION OF THE FIGURES

FIGS. 1-4 provide the results of testing indicating the foam stabilizing effects of brown sugar and glycerin.

### DETAILED DESCRIPTION OF THE INVENTION

In accordance with the present invention it has been discovered that certain combinations of surfactants (e.g., anionic surfactants and amphoteric surfactants) and one or more other components provide firefighting foam compositions exhibiting advantageous performance. Typically, the one or more other components comprises PEG and/or glycerin (propane-1,2,3-triol).

For example, various aspects of the present invention are directed to foam compositions including combinations of anionic surfactants including alkyl sulfate surfactants and amphoteric surfactants including amine oxide, betaine, and propionate surfactants, along with PEG. In accordance with these and other embodiments, the composition may also include glycerin, alone or along with PEG. Other embodiments involve foam compositions including the surfactant combinations described herein along with PEG and a sugar component (e.g., xylose).

These and other aspects of the present invention have been discovered to provide improved performance in terms of foaming quality when used with salt water (e.g., sea water), improved wettability in connection with Class A fire materials (e.g., according to U.S. Department of Agriculture, Forest Service (USFS), Specification Number 5100-307b), and improved performance in connection with Class B fires. For example, it has been discovered that foams of the present invention may exhibit improved spreading over liquid fuels, including foams providing a positive or neutral spreading coefficient. A tensiometer using ASTM Method D1331 may be used to measure the surface tension of compositions of the present invention and fuels, which may be used to calculate the spreading coefficient. For example, certain compositions of the present invention have provided the surface tension results shown by the data in the table below for a 3% synthetic fluorine-free foam (SFFF) solution.

| | Surface | IFT with | |
|---|---|---|---|
| | Tension | Jet Fuel | Spreading |
| Product | (mN/m) | (mN/m) | Coefficient |
| 3% SFFF | 25.62 | 0.17 | 1 |

In certain embodiments, therefore, a 3% SFFF foam of the present invention provides a surface tension (mN/m) of from about 22 to about 28, IFT with Jet Fuel (mN/m) of from about 0.1 to about 0.25, and a spreading coefficient of from 1 to 3.

Various embodiments of the present invention are suitable for knockdown and extinguishment of gasoline and Jet A fuel spill fires as identified in MIL-PRF-32725.

Generally, therefore, the foam compositions of the present invention include one or more surfactants, a foam stabilizer component, and one or more additional components.

### Surfactants

As noted above, in accordance with the present invention it has been discovered that combinations of certain surfactants along with other foam components provide various advantageous performance properties. Specifically, it has been discovered that certain combinations of anionic surfactants and amphoteric surfactants at various concentrations, ratios, etc. provide and/or contribute to foams providing one or more performance advantages.

### Anionic Surfactants

Suitable anionic surfactants generally include sulfate surfactants, sulfonate surfactants, and combinations thereof.

Suitable sulfate surfactants include branched and/or linear alkoxylated (e.g., ethoxylated) sulfate surfactants, and salts thereof, and amine sulfate surfactants.

For example, suitable alkyl sulfate surfactants include C8-C22, C8-C16, C8-C12, and C10-C12 alkyl sulfate surfactants, and salts thereof. Suitable salts include ammonium, alkali metal (e.g., sodium), and alkaline earth (e.g., magnesium) salts. Other suitable salts include amine salts and ethanolamine salts (e.g., triethanolamine, TEA, salts).

In certain embodiments, the anionic surfactant comprises at least one alkyl sulfate surfactant having a straight carbon chain having a length of 8 carbon atoms (octyl), 10 carbon atoms (capric), or 12 carbon atoms (lauryl).

In various embodiments, the anionic surfactant comprises lauryl sulfate or a salt thereof (e.g., TEA lauryl sulfate). In other embodiments, the anionic surfactant comprises octyl sulfate or a salt thereof (e.g., sodium octyl sulfate). In certain embodiments, the anionic surfactant comprises both lauryl sulfate or a salt thereof and octyl sulfate or a salt thereof. Other examples of suitable sulfate surfactants include decyl sulfate, cetyl sulfate, and combinations thereof.

Other suitable anionic surfactants include C8-C22, C8-C16, C8-C12, and C10-16 sulfonate surfactants. By way of further example, various embodiments include one or more C14-C16 sulfonate surfactants.

With reference to a firefighting foam concentrate, the total proportion of anionic surfactant is typically at least about 4 wt %, at least about 6 wt %, or at least about 8 wt %. In accordance with these and other embodiments, the total proportion of anionic surfactant is typically from about 4 wt % to about 12 wt %, from about 6 wt % to about 10 wt %, or from about 7 wt % to about 9 wt %.

Further, one or more of the anionic surfactants may be present in a total proportion of at least about 2 wt %, at least about 4 wt %, or at least about 5 wt %, based on the weight of the firefighting foam concentrate. In accordance with these and other embodiments, the total proportion of one or more anionic surfactants is typically from about 2 wt % to about 7 wt %, from about 2 wt % to about 6 wt %, or from about 3 wt % to about 6 wt %, based on the weight of the foam concentrate.

Where multiple anionic surfactants are present, there may be a first anionic surfactant and a second ionic surfactant present in a weight ratio (first:second anionic surfactant) of from about 1:5 to about 5:1, from about 1:4 to about 4:1, from about 1:3 to about 3:1, or from about 1:2 to about 2:1.

### Amphoteric Surfactants

Suitable amphoteric surfactants include propionate surfactants, betaine surfactants, sultaine surfactants, amine oxide surfactants, and salts thereof.

Suitable propionate surfactants include C6-C14 alkyl-iminodipropionate surfactants, and salts thereof. For example, suitable propionate surfactants include sodium octyliminodipropionate surfactants. Other suitable propionate surfactants include alkylamphopropionate surfactants.

Suitable betaine surfactants include C8-C22 betaine surfactants. For example, suitable betaine surfactants include lauramidopropyl betaine, cocamidopropyl betaine, and combinations thereof.

Suitable sultaine surfactants include C8-C22 sultaine surfactants.

Further in accordance with the present invention, although certain embodiments may include a sultaine surfactant, other embodiments do not include a sultaine surfactant. Accordingly, various embodiments of the present invention involve compositions that are substantially free or entirely free of sultaine surfactants.

With reference to a firefighting foam concentrate, the total proportion of amphoteric surfactant is typically at least about 10 wt %, at least about 14 wt %, or at least about 18 wt %. In accordance with these and other embodiments, the total proportion of anionic surfactant is typically from about 10 wt % to about 30 wt %, from about 14 wt % to about 26 wt %, or from about 18 wt % to about 22 wt %.

Further, one or more of the amphoteric surfactants may be present in a total proportion of at least about 4 wt %, at least about 6 wt %, or at least about 8 wt %, based on the weight of the firefighting foam concentrate. In accordance with these and other embodiments, the total proportion of one or more amphoteric surfactants is typically from about 4 wt % to about 14 wt %, from about 6 wt % to about 12 wt %, or from about 8 wt % to about 10 wt %, based on the weight of the foam concentrate.

Where multiple amphoteric surfactants are present, there may be a first amphoteric surfactant and a second amphoteric surfactant present in a weight ratio (first:second amphoteric surfactant) of from about 1:5 to about 5:1, from about 1:4 to about 4:1, from about 1:3 to about 3:1, or from about 1:2 to about 2:1.

Overall, the weight ratio of the total proportion of amphoteric surfactant(s) to anionic surfactant(s) is typically from about 1:5 to about 5:1, from about 1:4 to about 4:1, from about 1:3 to about 3:1, or from about 1:2 to 3:1 (e.g., about 2.5:1).

### Additional Components

As noted above, the foam compositions of the present invention include one or more other (i.e., additional) component(s) believed to provide or impart advantageous foam properties. Generally, the one or more additional components may include PEG, and/or glycerin (propane-1,2,3-triol), and/or a sugar component. In accordance with certain such embodiments, the additional component(s) comprise polyethylene glycol (PEG). In other such embodiments, glycerin.

Although referred to as “additional component(s)” herein, it is to be understood that both PEG and glycerin may also function as and be referred to as an organic solvent as well.

Suitable polyethylene glycols include high molecular weight PEGs and low molecular weight PEGs. Suitable high molecular weight PEGs include PEG 20000, PEG 30000, and PEG 35000. Suitable low molecular weight PEGs include PEG 200 to 1500.

In certain embodiments, the foam composition includes two or more additional components (organic solvents). For example, in certain embodiments, the comprises a suitable PEG and glycerin. In certain other embodiments, the composition may comprise butyl carbitol and polyethylene glycol.

Typically, the total proportion of additional solvent components is at least about 2 wt %, at least about 5 wt %, or at least about 10 wt %.

For example, in certain embodiments the total proportion of additional solvent components is from about 2 wt % to about 20 wt %, from about 2 wt % to about 15 wt %, or from about 5 wt % to about 15 wt %.

As noted above, further in accordance with the present invention a sugar component may be included as an additional component.

Suitable sugars include white sugar, carmelized sugars, monosaccharides, disaccharides, polysaccharides, and combinations thereof.

Examples of carmelized sugars include brown sugars (e.g., dark brown sugars).

Suitable monosaccharides include d-xylose, dextrose, glucose, fructose, galactose, and combinations thereof.

Suitable disaccharides include sucrose.

In accordance with various embodiments, the foam stabilizer includes multiple sugar components, e.g., brown sugar and xylose, or brown sugar and dextrose, or brown sugar and fructose.

With reference to firefighting foam concentrates, the sugar component is typically present in a concentration of at least about 10 wt %, at least about 15 wt %, or at least about 20 wt %. In accordance with certain embodiments, the sugar component is typically present in a concentration of from about 10 wt % to about 30 wt %, from about 10 wt % to about 25 wt %, or from about 15 wt % to about 25 wt %.

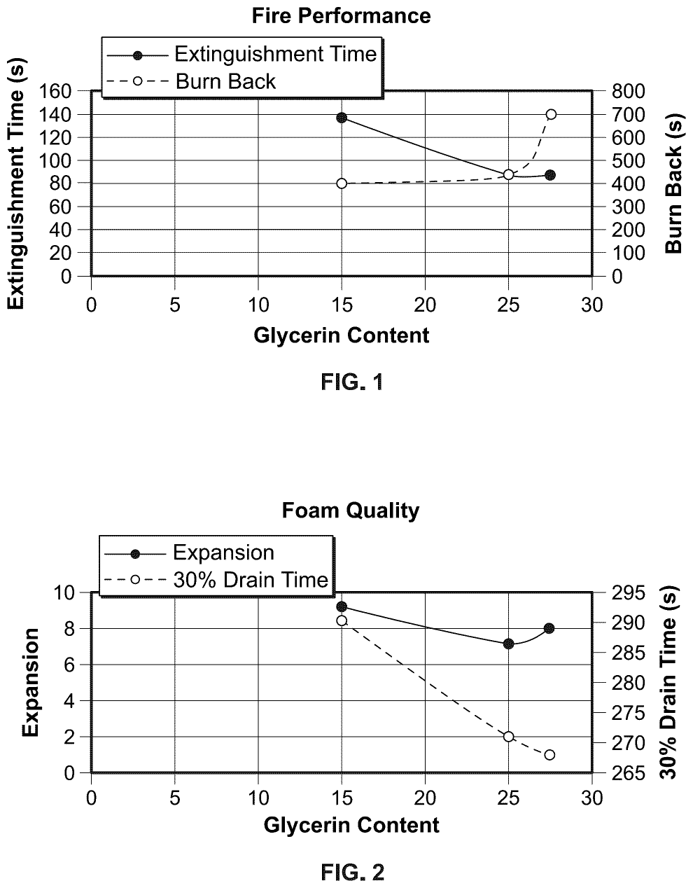

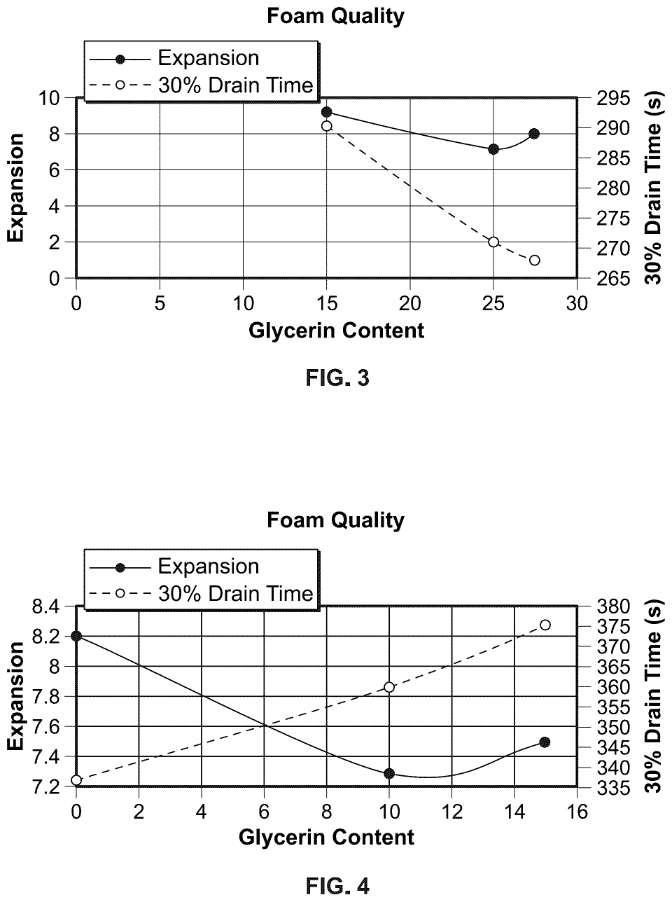

As noted, in accordance with the present invention, in various embodiments, the additional components include glycerin (propane-1,2,3-triol) along with the sugar component. It is currently believed the presence of glycerin (propane-1,2,3-triol) and/or a sugar provides improvements in foam properties. Evidence of the foam stabilizing effects of brown sugar and glycerin are shown in FIGS. 1-4.

Typically, when incorporated, glycerin is present in a proportion of at least about 5 wt %, at least about 8 wt %, at least about 10 wt %, or at least about 12 wt %. In accordance with these and other embodiments, the glycerin is typically present in a concentration of from about 5 wt % to about 30 wt %, from about 8 wt % to about 25 wt %, from about 8 wt % to about 20 wt %, from about 10 wt % to about 20 wt %, or from about 12 wt % to about 18 wt % (e.g., about 15 wt %).

Further in accordance with the foregoing embodiments and various other embodiments, the sugar component and glycerin are typically present in a weight ratio of from about 1:5 to about 5:1, from about 1:4 to about 4:1 or from about 1:3 to about 3:1.

Other components that may be included in the compositions of the present invention include pH adjustment components, including acidic compositions. These may include phosphoric acid and/or acetic acid.

Along with polyethylene glycol and/or glycerin (propane-1,2,3-triol), various other organic solvents may be incorporated into the compositions of the present invention. Such suitable organic solvents include alkyl glycols, polyols, and glycol ethers. Exemplary alkyl glycol diols include propylene glycol, butyl glycol, neopentyl glycol, hexylene glycol, ethylene glycol, 2-methyl-2,4-pentanediol, and combinations thereof. In accordance with certain embodiments, the organic solvent is an alkyl glycol diol selected from propylene glycol, butyl glycol, ethylene glycol, and combinations thereof. In certain embodiments, the organic solvent comprises butyl glycol.

Further in accordance with the present invention, the organic solvent may be a glycol ether. Suitable glycol ethers include propylene, n-butyl glycol ether, dipropylene glycol n-propyl ether, dipropylene glycol n-butyl ether, propylene glycol n-butyl ether (PNB), propylene glycol n-propyl ether, tripropylene glycol n-butyl ether, propylene glycol phenyl ether, dipropylene glycol phenyl ether, dipropylene glycol dimethyl ether, propylene glycol methyl ether, propylene glycol methyl ether acetate, dipropylene glycol methyl ether, dipropylene glycol methyl ether acetate, tripropylene glycol methyl ether, ethylene glycol hexyl ether; diethylene glycol hexyl ether; ethylene glycol propyl ether; diethylene glycol phenyl ether, ethylene glycol phenyl ether, poly(oxy-1,2-ethanediyl), alphaphenyl-omegahydroxy, diethylene glycol ethyl ether, diethylene glycol n-butyl ether, ethylene glycol n-butyl ether, butyl carbitol, and combinations thereof. In certain embodiments, the glycol ether is selected from the group consisting of propylene glycol, n-butyl glycol ether, butyl glycol, butyl carbitol, and combinations thereof.

In various embodiments, the organic solvent is selected from the group consisting of alcohols, diols (e.g., glycols), glycol ethers, and combinations thereof.

In particular, in certain embodiments, the composition includes one, two, or three glycol and/or glycol ether solvents. In various embodiments, the composition comprises a glycol solvent and a glycol ether solvent. In various other embodiments, the composition comprises a plurality of glycol ether solvents (e.g., two, or three glycol ether solvents).

In various embodiments, the one or more organic solvents are selected from the group consisting of propylene glycol, ethylene glycol, butyl carbitol, propylene glycol n-butyl ether (PnB), butyl glycol, hexylene glycol, and combinations thereof. In certain embodiments, the organic solvent comprises butyl carbitol.

In various other embodiments, the organic solvent(s) can include one or more of propylene glycol, hexylene glycol, butyl carbitol, propylene glycol n-butyl ether (PnB), and/or butyl glycol. In certain embodiments the one or more organic solvents comprise hexylene glycol and butyl carbitol. In other embodiments the one or more organic solvents comprise propylene glycol and butyl carbitol. In still other embodiments, the one or more organic solvents comprise butyl carbitol and propylene glycol n-butyl ether (PnB). By way of further example, the one or more organic solvents may comprise butyl carbitol and butyl glycol.

In certain embodiments, the foam composition includes one, two or three organic solvents. For example, in certain embodiments, the organic solvent comprises butyl carbitol and polyethylene glycol.

Typically, the total proportion of any additional solvents from those listed above is at least about 2 wt %, at least about 5 wt %, or at least about 10 wt %.

For example, in certain embodiments the total proportion of any such additional organic solvents is from about 2 wt % to about 20 wt %, from about 2 wt % to about 15 wt %, or from about 5 wt % to about 15 wt %.

### Foam Solutions

Typically, foam solutions of the present invention contain at least or about 0.5 wt %, 1 wt %, 1.5%, 2 wt %, 3 wt %, 4 wt %, 5 wt %, or 6 wt % of the foam concentrate. That is, the foam solutions are typically prepared from the foam concentrate by dilution with water at a dilution ratio (concentrate:water) of from 1:99 to 6:94. Test results reporting herein referring to foams as, for example 1%, 2%, etc. refer to the concentrate concentration in the solution (i.e., the rate of dilution of the concentrate).

### Foams

The compositions of the present invention are typically in the form of a concentrate and provided in equipment suitable for generation of foam. Suitable foam generating equipment includes aspirated foam generating devices, non-aspirated foam generating devices foam chambers, and sprinkler systems, in particular for use in a variety of sprinkler systems, including multi-head sprinkler systems.

Generally, the foams of the present invention are prepared by aspirating a foam solution of the present invention. Advantageously, the foams of the present invention are suitable for use with low expansion foam equipment and medium and high expansion foam discharge devices.

Foams of the present invention exhibit one or more advantageous properties in use and/or provide one or more efficiencies.

One advantage of the foams of the present invention is the foams providing improved performance when used with sea water. Results of such testing for foam compositions are set forth below.

| | Extinguishment Time | Burn |
|---|---|---|
| Test | (seconds) | Back (seconds) |
| 1% in Jet A | 37 | 480 |
| 1.5% in Jet A | 39 | 405 |
| 3% in Jet A | 36 | 465 |
| 3% Dry Chem | 37 | 410 |
| in Jet A | | |

Foams of the present disclosure thus may provide extinguishment times when used with sea water of from about 30 to about 50 seconds, from about 35 to about 45 seconds, or from about 35 to about 40 seconds when subjected to any or all of the tests listed above (e.g., 1% in Jet A, 1.5% in Jet A, 3% in Jet A, and/or 3% Dry Chem in Jet A). Additionally, or alternatively, foams of the present disclosure when used with sea water may provide burn back results (seconds) of from about 400 to about 500 seconds, or from about 450 to about 500 seconds when subjected to any or all of the tests listed above (e.g., 1% in Jet A, 1.5% in Jet A, 3% in Jet A, and/or 3% Dry Chem in Jet A).

Foams of the present invention also often provide improved spreading parameters over a liquid fuel to provide a positive or neutral spreading coefficient and wettability of Class A materials according to USFS Specification 5100-307b. EN 1568 and ASTM method may be used to quantify this performance.

Foams of the present invention are currently believed to at least meet, if not exceed performance standards known in the art including for example, military specifications (i.e., Mil-F-24385 and Mil-PRF-32725), ICAO (e.g., level A, B, C performance), LASTFIRE, FM, UL 162 land based operations standards, and/or sea operations standards. For example, compositions of the present invention have been observed to provide advantageous performance when tested for performance in connection with jet fuels, including Jet-A and Jet-A1.

### Methods for Fighting Fires

The compositions and foams of the present invention are suitable for use in methods for combatting and/or extinguishing a Class-B fire where a composition or foam composition is applied directly or indirectly onto a Class-B fire or the fuel ahead of a potentially advancing Class-B fire front.

In addition, embodiments of the present invention are currently believed to be suitable as Class-A foams. Class-A foams increase the effectiveness of water for direct suppression and mop up and can be used in both aerial and ground operations. It is further currently believed that certain embodiments of the present invention are suitable as Class-A/B foams, in particular fluorine-free Class-A/B foams. Class A/B foam can be used in multiple applications ranging from structural and residential fires; wildland fires; general facilities protection; Class A hazards (ordinary combustible materials such as wood, cloth, paper, rubber, and many plastics); Class B hazards that are not fuel in depth; (e.g., vehicle fires) and foam training exercises. Thus, various embodiments of the present invention are directed to firefighting foam concentrates suitable for use in forming Class-A and/or Class-A/B foams and the foams produced from such concentrates.

More generally, the foam compositions of the present invention are particularly suitable for use in fire prevention, fire suppression and extinguishment, vapor suppression, and wetting of surfaces.

### EXAMPLES

The following non-limiting examples are provided to further illustrate the present invention.

### Example 1

The following tables list compositions for a foam concentrate (e.g., a film forming solution) of the present invention.

Formulation 1:

| | Weight % |
|---|---|
| Water | 15-66% |
| Solvent | 6-40% |
| Preservative | 0-0.2% |
| C14—C16 Sulfonate (anionic) | 6-10% |
| C8—C12 Sulfate (anionic) | 5-13% |
| C10—C16 Amine oxide | 7-15% |
| (amphoteric) | |
| C10—C16 Betaine (amphoteric) | 4-11% |
| C6—C14 propionates | 0-3% |
| (amphoteric) | |
| Polyethylene glycol | 0-5% |

Formulation 2:

| | Weight % |
|---|---|
| Water | 15-66% |
| Solvent | 6-40% |
| C12 sulfosuccinate (anionic) | 0-3% |
| Preservative | 0-0.2% |
| C14—C16 Sulfonate (anionic) | 6-10% |
| C8—C12 Sulfate (anionic) | 5-13% |
| C10—C16 Amine oxide | 7-15% |
| (amphoteric) | |
| C10—C16 Betaine (amphoteric) | 4-11% |
| C6—C14 propionates | 0-3% |
| (amphoteric) | |
| Polyethylene glycol | 0-5% |

The freshwater fire test performance of compositions of the present invention is summarized in the table below:

| | Extinguishment | |
|---|---|---|
| Fresh Water | Time | Burn Back |
| Fire Test | (seconds) | (seconds) |
| 3% in Gasoline | 38 | 413.5 |
| 1.5% in Jet A | 26 | 327 |
| 3% in Jet A | 25 | 410.5 |
| 6% in Jet A | 23 | 426 |
| 3% in Jet A 50 sqft | 54 | 316 |
| 3% in Jet A with PKP | 23.5 | 276.5 |
| Aged 3% in Gasoline | 40.5 | 284.5 |
| Aged 1.5% in Jet A | 28 | 337 |
| Aged 3% in Jet A | 28.5 | 380 |

### Example 2

Following are descriptions of compositions that may be prepared in accordance with the present invention.

| | Formulation | Formulation | Formulation |
|---|---|---|---|
| | X | Y | Z |
| Component | wt. % | wt. % | wt. % |
| Water | 30-80 | 20-75 | 20-75 |
| Solvent | 6-10 | 6-25 | 5-30 |
| Sugar | 0-30 | 5-25 | 0-20 |
| Polyethylene glycol | 0-3 | 0-3 | 0-3 |
| C6—C18 sulfate | 1-12.5 | 1-9 | 0-1 |
| C8—C12 Succinate Salt | 0-2 | 0-2.3 | 1-9 |
| C8—C12 Sulfonate Salt | 0-10 | 1-12 | 0-3 |
| C8—C18 amine oxide | 0-12 | 1-16 | 1-7 |
| C8—C22 betaine | 0-11.5 | 2-10 | 4-12 |
| C8—C18 Hydroxysultaine | 0-11.5 | 0-7 | 1-10 |
| Alkyl polyglucosides | 0-5 | 0-3 | 0-7 |
| C6—C14 propionates | 0-5 | 0-7 | 0-9 |
| Cellulosic polymer | 0-1 | 0-1 | 0-10 |
| Preservative | 0-0.2 | 0-0.2 | 0-0.2 |
| pH adjustment | 0-0.2 | 0-0.2 | 0-0.2 |

Suitable solvents in the formulations listed above include glycol solvents and glycerin.

### EMBODIMENTS

For additional illustration, further and preferred embodiments of the present invention are set forth below.

Embodiment 1 is a firefighting foam concentrate, the concentrate comprising: at least one anionic surfactant; at least one amphoteric surfactant; and polyethylene glycol (PEG).

Embodiment 2 is the composition of Embodiment 1, wherein the concentrate comprises PEG 20000, PEG 30000, PEG 35000, or a combination thereof.

Embodiment 3 is the composition of Embodiment 1 or 2, wherein the concentrate further comprises glycerin (propane-1,2,3-triol).

Embodiment 4 is the composition of Embodiment 1 or 2, wherein the concentrate further comprises a sugar component.

Embodiment 5 is a firefighting foam concentrate, the concentrate comprising: at least one anionic surfactant; at least one amphoteric surfactant; and glycerin (propane-1,2,3-triol), wherein glycerin constitutes at least about 5 wt %, at least about 8 wt %, or at least about 10 wt % of the concentrate composition.

Embodiment 6 is a firefighting foam concentrate, the concentrate comprising: at least one anionic surfactant; at least one amphoteric surfactant; the composition further comprising: polyethylene glycol, and/or glycerin, and/or a sugar component, wherein: the composition does not contain any sultaine surfactant.

Embodiment 7 is the composition of any of the preceding Embodiments, wherein the at least one anionic surfactant comprises a branched and/or linear alkoxylated sulfate surfactant, or a salt thereof, or an amine sulfate surfactant.

Embodiment 8 is composition of any of the preceding Embodiments, wherein the at least one anionic surfactant comprises C8-C22, C8-C16, C8-C12, or C10-C12 alkyl sulfate surfactant, or a salt thereof.

Embodiment 9 is the composition of any of the preceding Embodiments, wherein the at least one anionic surfactant comprises at least one alkyl sulfate surfactant having a straight carbon chain having a length of at least 8 carbon atoms.

Embodiment 10 is the composition of any of the preceding Embodiments, wherein the total proportion of anionic surfactant is at least about 4 wt %, at least about 6 wt %, at least about 8 wt %, from about 4 wt % to about 12 wt %, from about 6 wt % to about 10 wt %, or from about 7 wt % to about 9 wt %.

Embodiment 11 is the composition of any of the preceding Embodiments, wherein the at least one amphoteric surfactant is selected from propionate surfactants, betaine surfactants, amine oxide surfactants, and salts and combinations thereof.

Embodiment 12 is the composition of Embodiment 11 wherein the at least one amphoteric surfactant comprises a C6-C14 alkyl-iminodipropionate surfactant, or a salt thereof.

Embodiment 13 is the composition of Embodiment 11 wherein the at least one amphoteric surfactant comprises a C8-C22 betaine surfactant, or a salt thereof.

Embodiment 14 is the composition of any of the preceding Embodiments, wherein the at least one amphoteric surfactant is present in a concentration of at least about 10 wt %, at least about 14 wt %, at least about 18 wt %, from about 10 wt % to about 30 wt %, from about 14 wt % to about 26 wt %, or from about 18 wt % to about 22 wt %.

Embodiment 15 is the composition of any of the preceding Embodiments, wherein the weight ratio of the at least one anionic surfactant to the at least one amphoteric surfactant is from about 1:5 to about 5:1, from about 1:4 to about 4:1, from about 1:3 to about 3:1, from about 1:2 to about 3:1, or about 2.5:1.

Embodiment 16 is the composition of any of the preceding Embodiments, wherein the sugar component comprises white sugar, a carmelized sugar, a monosaccharide, a disaccharide, a polysaccharide, or a combination thereof.

Embodiment 17 is the composition of Embodiment 16, wherein the sugar component comprises a carmelized brown sugar.

Embodiment 18 is the composition of Embodiment 16, wherein the sugar component comprises a monosaccharide selected from the group consisting of d-xylose, dextrose, glucose, fructose, galactose, and combinations thereof.

Embodiment 19 is the composition of any of the preceding Embodiments, wherein a sugar component is present in a concentration of at least about 10 wt %, at least about 15%, at least about 20%, from about 10 wt % to about 30 wt %, from about 10 wt % to about 25 wt %, or from about 15 wt % to about 25 wt %.

Embodiment 20 is the composition of any of the preceding Embodiments, wherein glycerin (propane-1,2,3-triol) is present in a proportion of at least about 8 wt %, at least about 10 wt %, at least about 12 wt %, from about 8 wt % to about 20 wt %, from about 10 wt % to about 20 wt %, from about 12 wt % to about 18 wt %, or about 15 wt %.

Embodiment 21 is the composition of any of the preceding Embodiments, wherein the sugar component and glycerin are present in a weight ratio of from about 1:5 to about 5:1, from about 1:4 to about 4:1, or from about 1:3 to about 3:1

Embodiment 22 is the composition of any of the preceding Embodiments, wherein the composition is substantially free or free of any sultaine surfactants.

Embodiment 23 is a firefighting foam solution, the solution comprising any of the concentrates of the preceding Embodiments, wherein the solution contains at least or about 0.5 wt %, 1 wt %, 1.5%, 2 wt %, 3 wt %, 4 wt %, 5 wt %, or 6 wt % of the foam concentrate.

Example embodiments have been provided so that this disclosure will be thorough, and will fully convey the scope to those who are skilled in the art. Numerous specific details are set forth such as examples of specific components, methods, etc. to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes and well-known technologies are not described in detail.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, and/or sections, these elements, components, and/or sections should not be limited by these terms. These terms may be only used to distinguish one element, component, or section from another element, component, or section. Terms such as “first,” “second,” and other numerical terms when used herein do not imply a sequence or order unless clearly indicated by the context. Thus, a first element or component could be termed a second element or component without departing from the teachings of the example embodiments.

In view of the above, it will be seen that the several objects of the invention are achieved and other advantageous results attained.

As various changes could be made in the above without departing from the scope of the present disclosure, it is intended that all matter contained in the above description shall be interpreted as illustrative and not in a limiting sense.

Having described the present disclosure in detail, it will be apparent that modifications and variations are possible without departing from the scope of the present disclosure defined in the appended claims.

What is claimed is:

1-23. (canceled)

24. A firefighting foam concentrate, the concentrate comprising:
a solvent comprising butyl carbitol, wherein butyl carbitol is present in a proportion of from about 2 wt % to about 20 wt % of the composition;
polyethylene glycol (PEG) in a proportion of at least about 2 wt %; and
glycerin in a proportion of from about 5 wt % to about 30 wt %, wherein the composition further comprises:
a plurality of anionic surfactants selected from C8-C16 alkyl sulfate surfactants and salts thereof, and
a plurality of amphoteric surfactants selected from propionate surfactants, betaine surfactants, sultaine surfactants, amine oxide surfactants, and combinations thereof.

25. The composition of claim 24, wherein butyl carbitol is present in a proportion of from about 5 wt % to about 15 wt %.

26. The composition of claim 24, wherein glycerin is present in a proportion of from about 10 wt % to about 20 wt %.

27. The composition of claim 24, wherein glycerin is present in a proportion of from about 12 wt % to about 18 wt %.

28. The composition of claim 24, wherein the plurality of anionic surfactants comprises octyl sulfate or a salt thereof and lauryl sulfate or a salt thereof.

29. The composition of claim 28, wherein the total proportion of anionic surfactants is at least about 4 wt %.

30. The composition of claim 28, wherein the total proportion of anionic surfactants is from about 4 wt % to about 12 wt %.

31. The composition of claim 28, wherein the plurality of anionic surfactants comprises sodium octyl sulfate and triethanolamine lauryl sulfate.

32. The composition of claim 24, wherein the total proportion of amphoteric surfactants is at least about 10 wt %.

33. The composition of claim 24, wherein the total proportion of amphoteric surfactants is from about 10 wt % to about 30 wt %.

34. The composition of claim 24, wherein the plurality of amphoteric surfactants comprises a propionate surfactant, a betaine surfactant, and a sultaine surfactant.

35. The composition of claim 34, wherein the plurality of amphoteric surfactants comprises a C6-C14 alkyl-iminodipropionate surfactant, or a salt thereof, a C8-C22 betaine surfactant, and a C8-C22 sultaine surfactant.

36. The composition of claim 35 wherein the plurality of amphoteric surfactants comprises sodium octyliminodipropionate surfactant, lauramidopropyl betaine surfactant, and a C8-C22 sultaine surfactant.

37. The composition of claim 24, wherein the plurality of amphoteric surfactants comprises a propionate surfactant, a betaine surfactant, a sultaine surfactant, and an amine oxide surfactant.

38. The composition of claim 37, wherein the plurality of amphoteric surfactants comprises sodium octyliminodipropionate surfactant, lauramidopropyl betaine surfactant, a C8-C22 sultaine surfactant, and lauramine oxide surfactant.

39. A firefighting foam concentrate, the concentrate comprising:
a solvent comprising butyl carbitol;
polyethylene glycol (PEG); and
glycerin, wherein the composition further comprises:
a plurality of anionic surfactants, wherein the plurality of anionic surfactants comprises octyl sulfate or a salt thereof and lauryl sulfate or a salt thereof; and
a plurality of amphoteric surfactants, wherein the plurality of amphoteric surfactants comprises sodium octyliminodipropionate surfactant, lauramidopropyl betaine surfactant, and a C8-C22 sultaine surfactant.

40. A firefighting foam solution, the solution comprising the concentrate of claim 39, wherein the solution contains at least or about 3 wt % of the foam concentrate.

41. A firefighting foam concentrate, the concentrate comprising:
a solvent comprising butyl carbitol;
polyethylene glycol (PEG); and
glycerin, wherein the composition further comprises:
a plurality of anionic surfactants, wherein the plurality of anionic surfactants comprises octyl sulfate or a salt thereof and lauryl sulfate or a salt thereof; and
a plurality of amphoteric surfactants, wherein the plurality of amphoteric surfactants comprises sodium octyliminodipropionate surfactant, lauramidopropyl betaine surfactant, a C8-C22 sultaine surfactant, and lauramine oxide surfactant.

42. A firefighting foam solution, the solution comprising the concentrate of claim 41, wherein the solution contains at least or about 1 wt % of the foam concentrate.

43. A firefighting foam concentrate, the concentrate comprising:
a solvent comprising butyl carbitol, wherein butyl carbitol is present in a proportion of from about 2 wt % to about 20 wt % of the composition;
polyethylene glycol (PEG);
glycerin in a proportion of from about 5 wt % to about 30 wt %; and
a sugar component selected from a white sugar, a carmelized sugar, a monosaccharide, a disaccharide, a polysaccharide, a carmelized brown sugar, or a combination thereof; wherein the composition further comprises:
a plurality of anionic surfactants selected from C8-C16 alkyl sulfate surfactants and salts thereof, and
a plurality of amphoteric surfactants selected from propionate surfactants, sultaine surfactants, and combinations thereof.

44. The composition of claim 43, wherein the plurality of anionic surfactants comprises octyl sulfate or a salt thereof and lauryl sulfate or a salt thereof.

45. The composition of claim 44, wherein the total proportion of anionic surfactants is at least about 8 wt %.

46. The composition of claim 43, wherein the plurality of anionic surfactants comprises sodium octyl sulfate and triethanolamine lauryl sulfate.

47. The composition of claim 46, wherein the plurality of amphoteric surfactants comprises sodium octyliminodipropionate surfactant and a C8-C22 sultaine surfactant.

48. The composition of claim 47, wherein the total proportion of amphoteric surfactants is at least about 18 wt %.

49. A firefighting foam solution, the solution comprising the concentrate of claim 43, wherein the solution contains at least or about 1 wt % of the foam concentrate.
